(19) United States
(12) Patent Application Publication
(10) Pub. No.: US 2014/0361020 A1
(43) Pub. Date: Dec. 11, 2014

(54) Partially Insulated Cooking Vessel

(71) Applicant: Meyer Intellectual Properties Limited, Hong Kong (CN)

(72) Inventor: Stanley Kin Sui Cheng, Hillsborough, CA (US)

(73) Assignee: MEYER INTELLECTUAL PROPERTIES LIMITED, Hong Kong (CN)

(21) Appl. No.: 14/373,570

(22) PCT Filed: Jan. 21, 2013
(86) PCT No.: PCT/US13/22403

§ 371 Date: Jul. 21, 2014

Related U.S. Application Data
(60) Provisional application No. 61/590,798, filed on Jan. 25, 2012.

(51) Int. Cl. A47J 36/02; B23P 19/04; B23K 1/00

(52) U.S. Cl. CPC A47J 36/02; B23K 1/00; B23P 19/04
USPC 220/573.1; 29/525.14

(57) ABSTRACT

A cookware vessel has an upper portion of the surrounding sidewall that is insulated by a cavity to maintain the temperature of the food cooked therein until and during the service of food from the vessel. A highly conductive metal layer, such as a copper layer, extends upward along the inner wall surface adjacent to the inner vessel to spread heat from the bottom of the vessel up the inner sidewall. The copper layer is bonded to the both the inner and outer vessel at the bottom of the vessel and portions of the outer sidewall that would otherwise be overheated by a burner flame and then discolor. In a preferred embodiment, the brazing compound comprises silver to further improve thermal conduction. The copper layer may also extend to the bottom exterior of the vessel to provide an improved means from measuring the temperature of the contents during cooking.

### CROSS REFERENCE TO RELATED APPLICATIONS

The present application claims the benefit of priority to the US Provisional Patent Application of the same title, that was filed on Jan. 25, 2012, having application Ser. No. 61/590,798, and which is incorporated herein by reference.

The present application also claims the benefit of priority to the PCT application of the same title, that was filed on 21 Jan. 2013, having International application no. PCT/U.S.2013/022403, and is incorporated herein by reference.

### BACKGROUND OF INVENTION

The present invention relates to a cookware article and in particular to pots and pans with a double sidewall construction, in which a gap between the double walls provide thermal insulation.

Prior forms of hollow wall cooking vessels have inferior cooking performance to the extent that the most of the heating of the foodstuffs is from the bottom of the cookware vessel, as the sidewalls are not intended to conduct heat, but rather provide insulation.

Such constructions are susceptible to the exterior portion of the hollow wall closest to the heating source or flame is overheated and in the case of stainless steel rapidly develops a burned or tarnished appearance.

It is therefore a first object of the present invention to provide improved hollow wall cooking vessels wherein the cooking performance is not compromised by the insulating qualities, and the insulating qualities do not make the exterior susceptible to staining or burning.

Another objective of the present invention is to provide a method of forming a cookware article having these attributes wherein there is provided in the lower portion of the sidewalls between the inner and outer vessel a sufficient mass of thermally conductive material to avoid damage or discoloration from the heating element, such as flames.

### SUMMARY OF INVENTION

In the present invention, the first object is achieved by providing a article of cookware, comprising a substantially horizontal bottom, substantially upright sidewall extending upward from and encircling said bottom to form a fluid retaining interior region, the upright sides walls terming in an upper surface to define a rim of the cookware article that is capable of holding fluid below the rim; the bottom and a lower portion of the upright sidewall having a clad construction of a at least of conductive metal laminated between tow layer of less conductive metal, wherein the upper portion of the sidewall is separated from the conductive metal to define a cavity, the cavity extending upward to an under surface of the rim, the under surface of the rim being formed of the inner layer of the cookware article.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a cross-sectional elevation of a first embodiment of a cooking vessel, whereas FIG. 1B is an expanded view of a portion thereof.

FIG. 2A-E illustrate the steps in a method of forming the vessel of FIG. 1A and 1B.

FIG. 3A is a cross-sectional elevation of a second embodiment of a cooking vessel, whereas FIG. 3B is an expanded view of a portion of this alternative embodiment.

FIG. 4A-E illustrate the steps in a method of forming the vessel of FIG. 3A and 3B.

FIG. 5A-5G illustrate the steps in an alternative method of forming the vessel of FIG. 1A and 1B.

FIG. 6A is a cross-sectional elevation of another embodiment of a cooking vessel, whereas FIG. 6B is an expanded view of a portion of this alternative embodiment.

### DETAILED DESCRIPTION

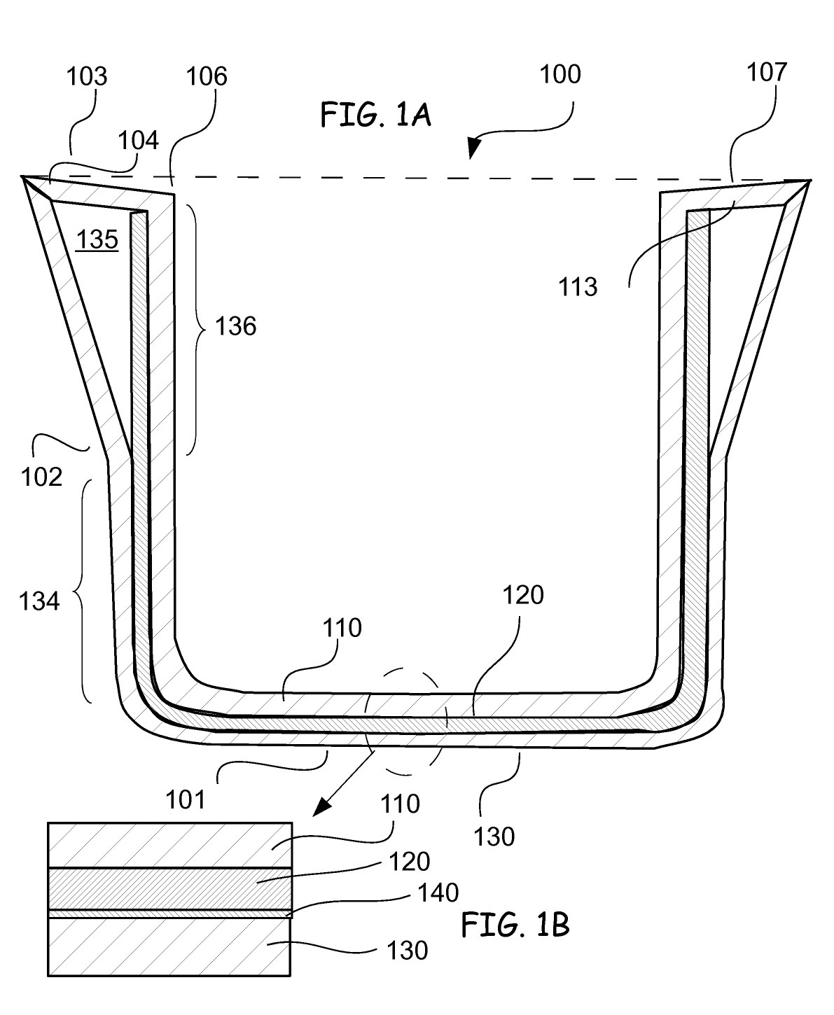

Referring to FIGS. 1A through 6B, wherein like reference numerals refer to like components in the various views, there is illustrated therein a new and improved Partially Insulated Cooking Vessel, generally denominated 100 herein.

In accordance with the present invention, the cooking vessel 100 has a bottom cooking surface 101 for direct exposure to a heat source. Upright walls 102 are connected to and surround the bottom 101 extending upward to a rim region 103. The lower portion 134 of the upright wall 102 has a laminated construction of three layers, 130, 120 and 110. In the upper portion 136 of the wall 102, the outer layer 130 is separated from the more thermally conducting inner 120 layer to form a cavity 135 at the upper wall portion 136. The outer layer 130 and inner layer 110 are connected within rim region 103 at a common outer rim 104 by a weld. The rim region includes an inner rim 106 at the upper extent of the inner wall defined generally by the inner layer 110.

It is preferable that the upper portion 136 of the wall 102 is about the same height as the lower portion 134, or about half the vertical height of the vessel 100.

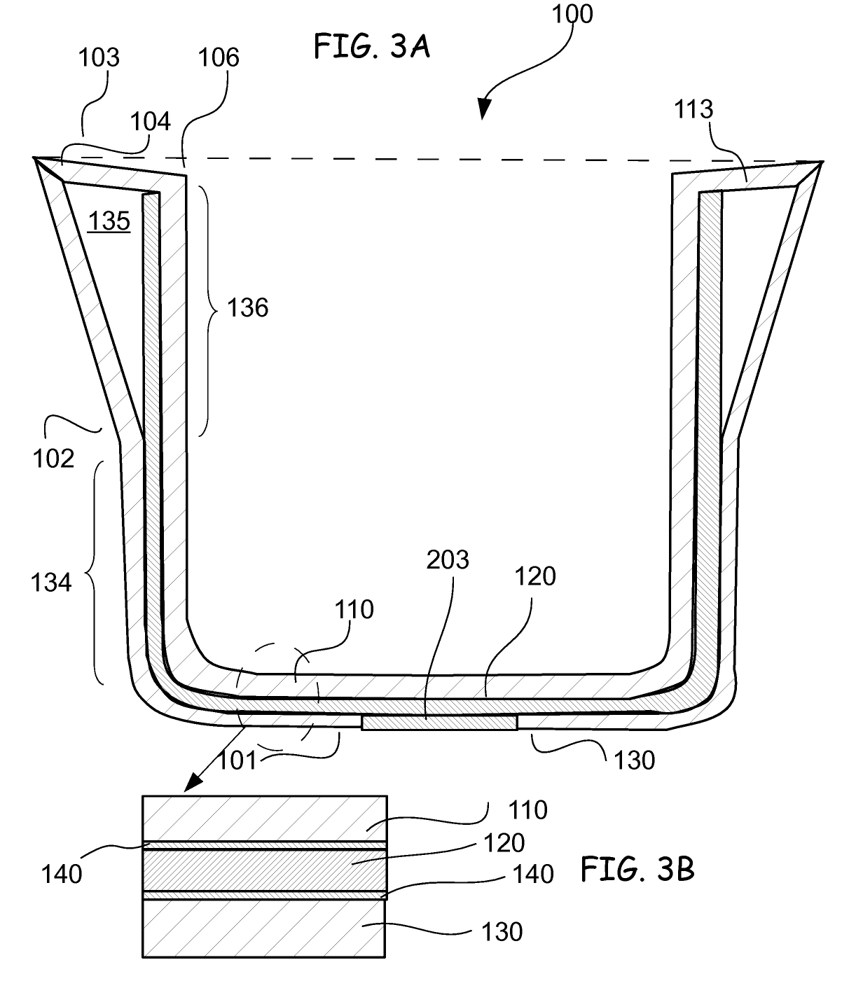

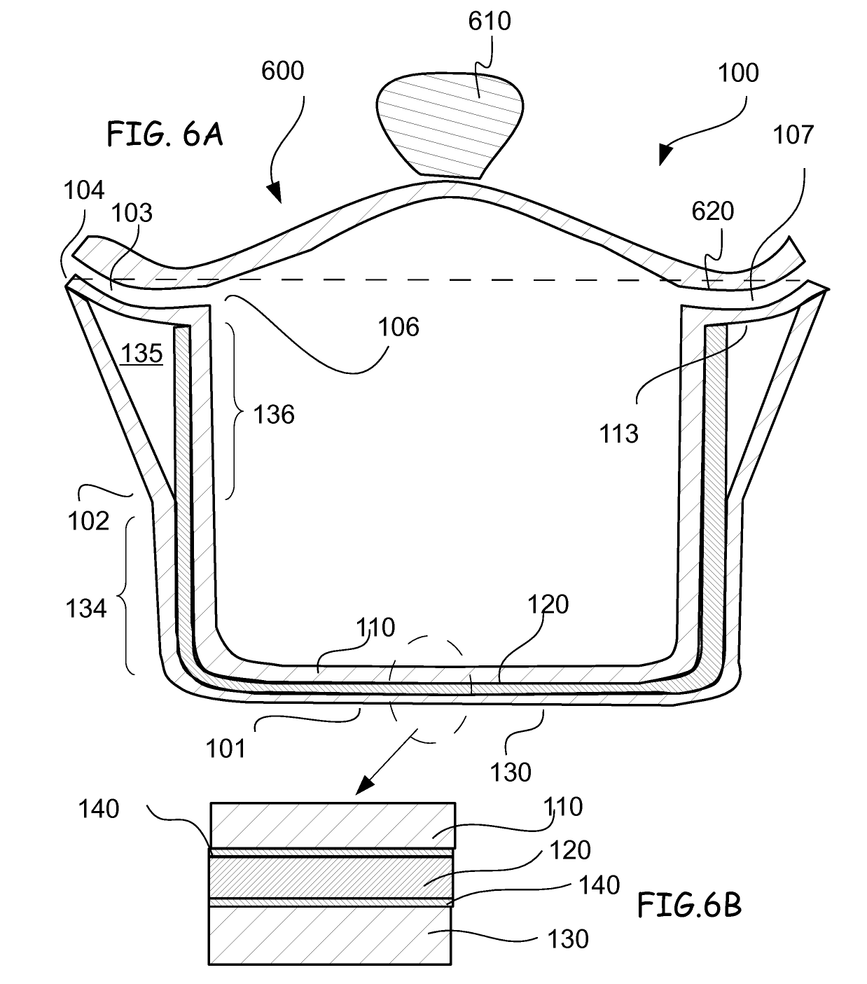

Thus, the rim region includes a flange 107 extending from the inner rim 106 to the welded outer rim 104. In the preferred embodiments of FIG. 1A and FIG. 3A, flange 107 is a frusto-conical section. Alternatively, flange 107 can have the shape described with respect to FIG. 6.

Within cavity 135 opposite flange 107 a portion of the interior layer 113 in an outward flared portion of the inner wall 110 is separated from more thermally conducting inner layer 120 adjacent to the weld 104. Preferably layer 110 is stainless steel and preferably between about 0.4 to 1 mm thick, layer 120 is preferably copper and preferably between about 0.5 to 2 mm thick, and layer 130 is also preferably stainless steel, particularly magnetic stainless steel, and preferably about 0.5 to 1 mm thick. Alternatively, layer 120 can be aluminum or copper clad aluminum, preferably between about 1-5 mm thick.

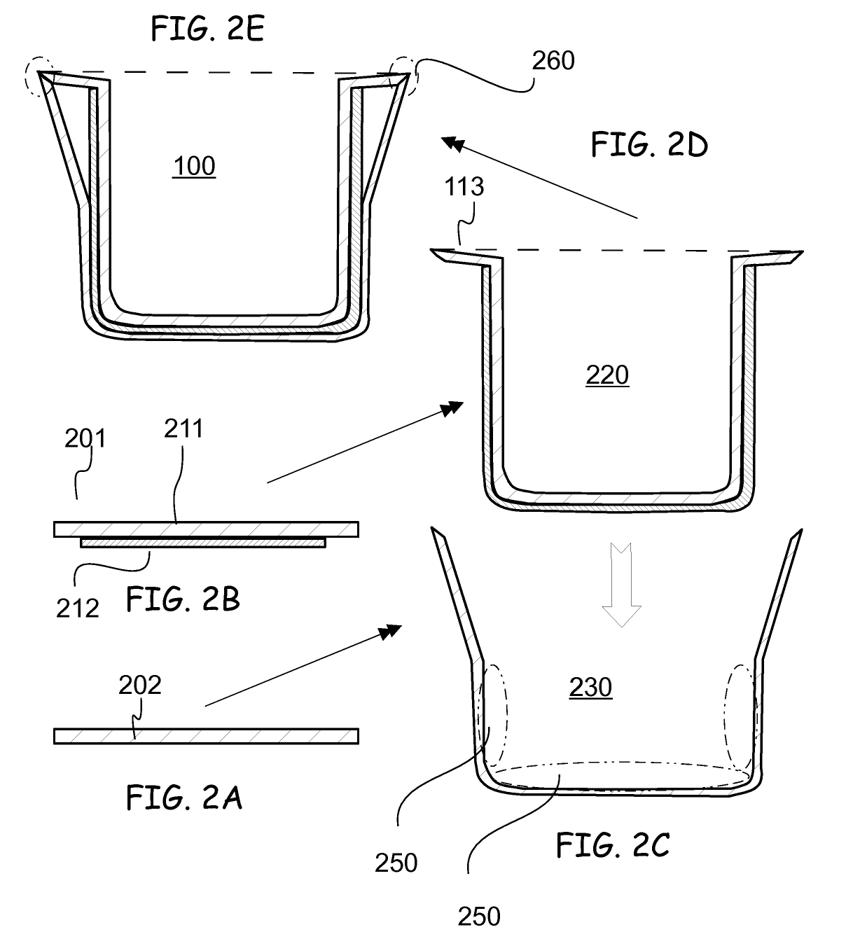

Another embodiment of the invention is a method for fabricating vessel 100, (FIG. 2A-2E) in which as a first step is optionally providing or forming vessel preforms 220 and 230, such as by deep drawing metal sheets 201 and 202 respectively. In this embodiment, metal sheet 201 has at least 2 clad or bonded layers 211 and 212. Preform 220 is sized for close or tight nesting with preform 230, for subsequent bonding by any combination of impact bonding, brazing and ironing of the portion 134 of the sidewalls shown in FIG. 1. A precursor to separated region 113 is created by removing the perimeter portion of the more thermally conducting layer 212/120 either before or after forming into perform 220. Flange 107 is formed or provided before the nesting and boding process, which includes the welding of the two preforms at outer rim 104. Vessel 100 optionally also includes a further layer 140, of silver, when brazed in this method as shown in FIG. 1B. This construction provides for efficient heat transfer to the entire contents of the vessel, but minimizes heating of the rim, and provides thermal insulation in a portion of the sidewall distal from the flame or heat source to avoid staining or burning, as can occur with a stainless steel vessel. Minimization of the heating of the rim is particularly important for several reasons. First, it minimized the potential for also heating any side handles attached to the outer sidewall just outside the rim, and further, in the case of the so called “waterless” cooking vessel of FIG. 6A, enables the cooler rim to condense water that serves as a low pressure vapor trap. All other constructions of the prior art make a compromise between keeping the contents warm, by effective conduction from the bottom with insulation in the sidewall, and yet avoiding overheating the rim.

Further, the inner perform 220 can also be formed by brazing or otherwise attaching and boding two concentric and nesting single layer performs, such as stainless steel to copper, or by forming laminate in which planar disks of copper and stainless steel are concentrically aligned and then brazed together with a silver brazing compound before forming into the inner perform 220. Such a process can yield an alternative laminate structure shown in FIG. 3B, in which a silver brazing compound is disposed on bother side of the core copper layer 120. In such case, the silver layers 140 enhance the thermal conduction of heat from the bottom of the vessel to the entire sidewall. In addition, as handles are generally attached adjacent or below the rim, in region 135, excess heating of the handles is avoided as well.

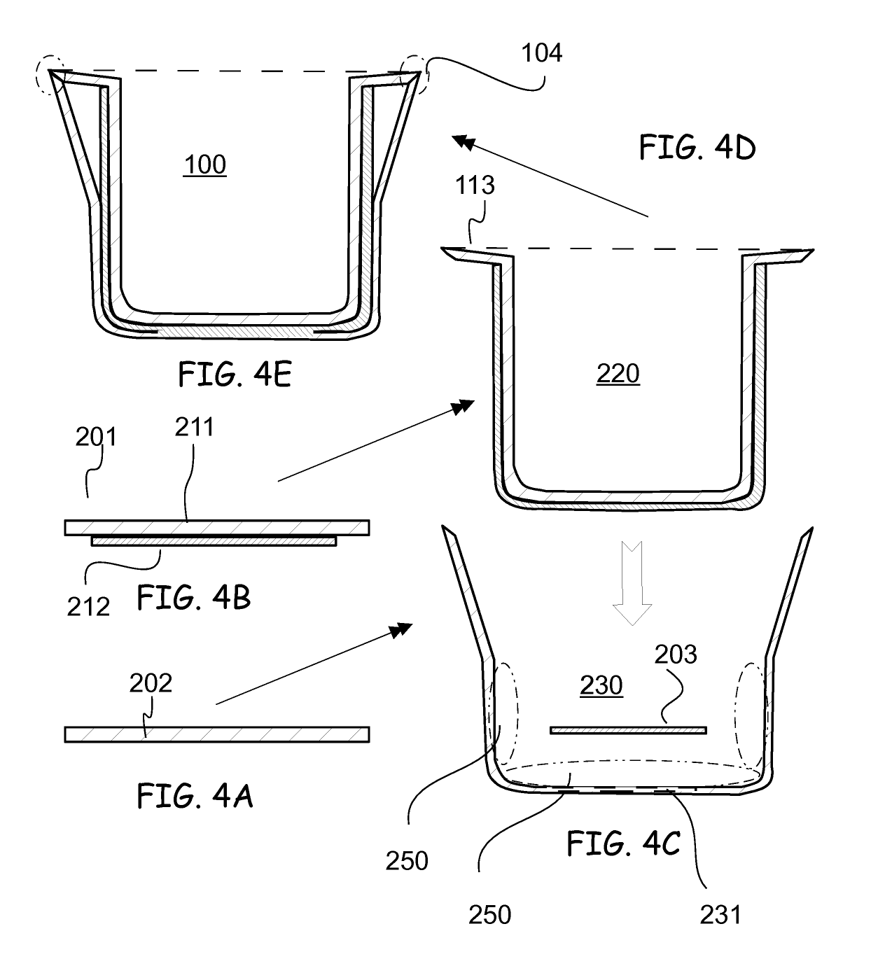

In the process of joining the inner and outer preforms in FIG. 2C and 4C, ironing may be deployed to bond the layers at the lower wall portion 134.

When the more thermally conducting layer 212 is copper, them a silver brazing compound is applied to the regions 250 where the interior of the outer vessel 230 contacts the exterior copper of the inner vessel 220. After attaching the inner and outer vessel, the adjacent portions of the rims are welded together at region 260 to form outer rim 104. In other embodiments impact bonding and/or ironing may be applied to join the performs in the steps shown in FIG. 2C and 4C.

However, alternative brazing compounds to silver for joining stainless steel and copper or aluminum are known, and may be deployed in other embodiments of the invention. It should also be appreciated that other brazing compounds than silver can be used, depending on the choice of metals for layers 120 and 130.

In the embodiment shown in FIG. 3-4, the exterior bottom of the vessel 100 is the same or more thermally conducting material as layer 120, being formed of an additional disc 203 inserted in the bonding process step shown in FIG. 4C above the aperture 231 formed in the bottom of prefrom 230. Placing the more conducting material at the bottom of the pan provides a more facile means to measure the approximate temperature of the vessel and the foodstuff thereof from this outer bottom surface.

Further, when the outer metal is magnetic stainless steel for induction cooking the central area will only be heated indirectly; making the temperature measured thereat more representative of the food temperature at the bottom interior cooking surface.

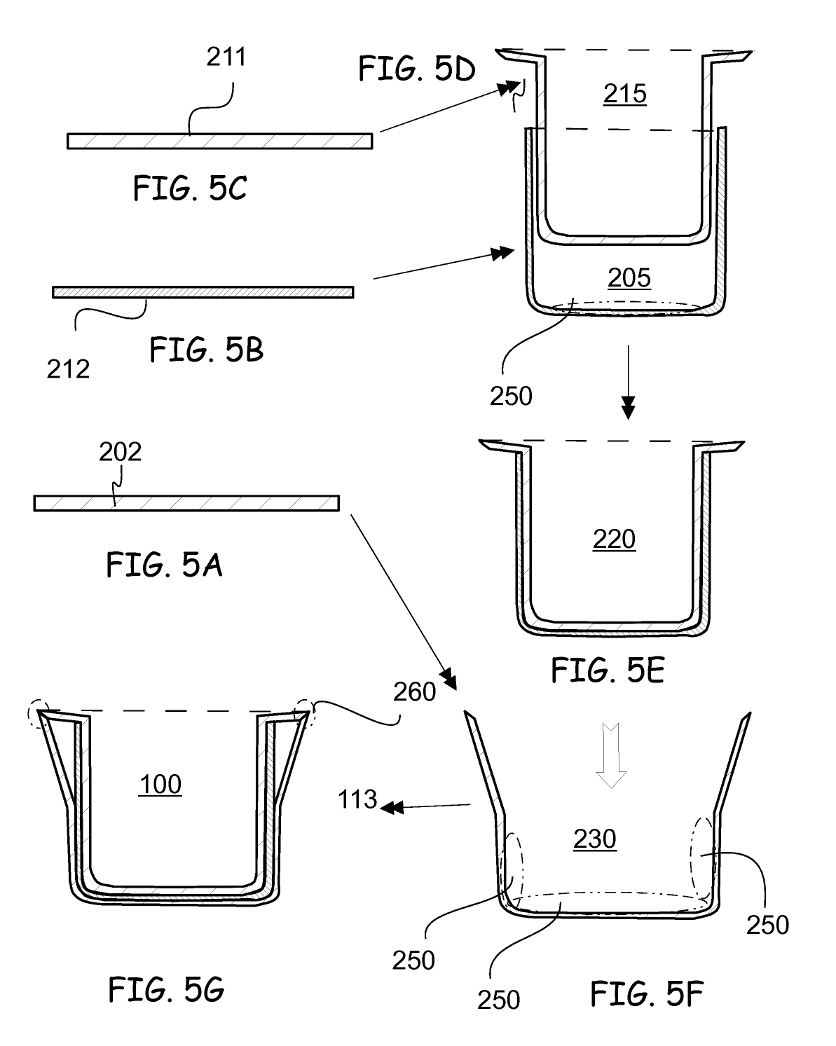

In another embodiment of the invention vessel 100 may be fabrication from 3 previously formed preformed vessels, as is illustrated in FIG. 5. Further, the inner perform 220 can also be formed by joining two single layer performs 205 and 215 after nesting, such as by a combination of impact bonding, brazing and ironing. Preforms 205 is formed by deep drawing planar sheet 212. Preforms 215 is formed by deep drawings planar sheet 211, including forming the flared or spread rim flange 107 during or after deep drawing, as well as after attachment to form inner preform 220. In the steps illustrated in FIG. 5F, preform 220 is inserted in prefrom 230 for joining as described above with respect to FIG. 2D-2E.

such as stainless steel to copper, or by forming laminate in which planar disks of copper and stainless steel are concentrically aligned and then brazed together with a silver brazing compound before forming into the inner perform 220. Such a process can yield an alternative laminate structure shown in FIG. 3B. In such case, the silver layer enhances the thermal conduction of heat from the bottom of the vessel to the entire sidewall. In addition, as handles are generally attached adjacent or below the rim, in region 135, excess heating of the handles is avoided as well.

FIG. 6 illustrates an alternative embodiment of the invention in which a lid 600 is adapted to fit an alternatively shaped rim flange 107 which preferably has a curvilinear shaped portion than includes a central depression for collecting a thin film of condensed water vapor to form a low pressure vapor tight seal. The lid 600 is lifted by the attached handle 610 for closing the vessel 100 with the lid periphery 620 having a contour to rim flange 107.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware, comprising:
a) a substantially horizontal bottom,
b) an inner and an outer sidewall extending substantially upward from and encircling said bottom to form a fluid retaining interior region,
c) wherein the inner sides walls terminates at an upper surface to define an interior rim of the cookware article that is capable of holding fluid below the rim, and the outer sidewall flares away form the inner side walls to terminate at an outer rim the extends beyond a periphery of the inner rim, wherein the inner and outer rim are connected by a flange,
d) wherein the bottom and a lower portion of the inner sidewall having a clad construction of at least one of conductive metal core laminated between at least two layer of less conductive metal, wherein conductive metal core in the upper portion of the inner sidewall is separated from an outward surrounding layer of less conductive material upward from the position at which the outer sidewall flares away form the inner sidewall, and wherein the conductive metal core then extends to connect and terminate at the inner rim, wherein the flared portion of the outer sidewall, the flange and the conductive metal core at the upper portion of the inner sidewall define the interior bounds of an insulated cavity that us disposed under the flange.

2. The article of cookware of claim 1 in which the upper portion of the inner sidewall adjacent the cavity has a height that is at least a third of the height of the inner sidewall.

3. The article of cookware according to claim 1 wherein the inner and outer clad layers are stainless steel and the metal core comprises copper, and further comprising at least one silver compound disposed between at least a portion of the copper core and one of the stainless steel layers.

4. The article of cookware according to claim 1 wherein the interior rim is lower than the exterior rim.

5. The article of cookware according to claim 1 wherein the inner core layer is exposed at a portion of an exterior surface of the substantially horizontal bottom.

6. The article of cookware according to claim 1 wherein a centrally disposed portion of the outer clad layer that forms the exterior surface of the substantially horizontal bottom is perforated.

7. The article of cookware according to claim 2 further comprising at least an additional coin like portion of the core material that extends downward from the core metal layer to fill the perforated centrally disposed portion of the outer clad layer.

8. The article of cookware according to claim 1 wherein the outer clad layer is stainless steel.

9. The article of cookware according to claim 1 wherein the inner clad layer is stainless steel.

10. The article of cookware according to claim 1 wherein the outer clad layer is magnetic stainless steel.

11. The article of cookware according to claim 1 wherein the metal core is copper or an alloy thereof.

12. The article of cookware according to claim 1 wherein the outer rim is welded to the outer sidewall.

13. The article of cookware according to claim 1 wherein the flange has a frusto-conical shape.

14. The article of cookware according to claim 1 wherein the flange is curvilinear shaped and includes a central depression.

15. The article of cookware according to claim 4 wherein the conductive metal core is copper or an alloy thereof.

16. A method of forming an article of cookware, the method comprising the steps of
a) providing at least one inner vessel preform and an outer vessel preform,
i) wherein each preform has a bottom surface and connected surrounding sidewalls that extend upward to terminate at a rim,
ii) wherein the rim of the outer vessel preform has an inner rim at an inner most extension of the surrounding sidewalls, and then connects to a flange that extends outward from the inner rim to terminate at an outer rim,
iii) wherein the bottom surface and connected surrounding sidewalls of the inner vessel have a clad construction, in which the cladding extends no farther than the inner rim,
iv) wherein the sidewall of the outer vessel preform has a lower portion and an upper portion above the lower portion, the upper portion flaring outward from the lower portion to terminate at the rim,
b) nesting the inner vessel preform in the outer vessel perform to align the rim of the outer perform with the outer rim of the inner perform,
c) attaching the bottom of the inner preform to the bottom of the outer preform,
d) attaching the rim of the outer prefrom to outer rim of the inner preform to form an article of cookware having an annular cavity in an upper portion of a sidewall.

17. The method of forming an article of cookware according to claim 16 wherein the flange has a frusto-conical shape.

18. The method of forming an article of cookware according to claim 16 wherein said step of attaching the bottom of the inner preform to the bottom of the outer preform comprises brazing.

19. The method of forming an article of cookware according to claim 16 further comprising a step of ironing to attach the sidewalls of the inner preform to the sidewalls of the outer preform.

20. The method of forming an article of cookware according to claim 16 wherein the outer preform has a central hole at the bottom and further comprising a step of inserting a the coin in the central hole wherein said step of attaching the bottom of the inner preform to the bottom of the outer preform fills the central hole with the coin.

21. The method of forming an article of cookware according to claim 19 wherein the coin comprises copper and at least an outer surface of the inner vessel preform comprises copper.

22. The method of forming an article of cookware according to claim 18 wherein said step of wherein said step of attaching the bottom of the inner preform to the bottom of the outer preform by brazing wherein the brazing compound is applied between contacting lower portion of the inner perform and the outer perform before said step of nesting.

23. The method of forming an article of cookware according to claim 18 wherein the brazing compound applied between contacting lower portion of the inner perform and the outer perform comprises silver.
